(19) United States
(12) Patent Application Publication
(10) Pub. No.: US 2008/0197169 A1
(43) Pub. Date: Aug. 21, 2008

(54) Method and device for providing an electric connection

(75) Inventor: Johan Bavhammar, Staffanstorp (SE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Safetrack Infrasystems SISAB AB, Staffanstorp (SE)

(21) Appl. No.: 12/070,467

(22) Filed: Feb. 19, 2008

(30) Foreign Application Priority Data
Feb. 19, 2007 (SE) 0700396-5

(51) Int. Cl. B23K 1/19; B23K 3/08

(52) U.S. Cl. 228/44.7; 228/136; 219/85.16; 219/85.22; 219/78.16; 228/49.5

(57) ABSTRACT

A method for providing an electric connection between a wire (12) and a metal surface (10) by pressing a curved and stripped section (11) of the wire towards the metal surface and arranging a brazing pin (14) in close proximity to a concave side of the curved section. Electric power is supplied to the brazing pin in a pinbrazing process until a fluxing agent and a solder material carried by the brazing pin has been released and melted.

A brazing gun (18) is electrically connected to a power supply (19), the brazing gun having an opening for holding a brazing pin, and the brazing pin having a circular cross section. A bending tool is used for bending a stripped section of an electric wire to a circular shape, wherein the diameter of the bent wire is adapted to the diameter of the brazing pin, and means are provide for pressing the bent wire against the metal surface while generating an arc between the brazing pin and the metal surface.

### TECHNICAL FIELD

The invention relates to a method and a device for providing an electric connection between a wire and a metal surface. The metal surface may be a part of a pipeline or other construction that is put to operate in an electrolytic environment. The invention can be used in connection with cathodic protection systems. Cathodic protection systems are employed to prevent corrosion of metal structures exposed to an electrolytic environment.

Cathodic protection can be effected for submarine or subterranean and other corrodible structures by electrically connecting the corrodible structure to sacrificial anodes constructed of a metal that is higher in the electromotive series than the protected structure, i.e., a metal that is anodic to the material of the protected structure. When the protected structure and the electrically connected sacrificial anode are both disposed within the same electrolytic environment (e.g., earth or water containing free positive ions), a galvanic cell is formed in which the protected structure is the cathode. A sacrificial anode also can be defined as a metal that is more easily oxidized than the protected metal. Electrons are stripped from the anode and conducted to the protected metal, which, for this reason, is forced to become the cathode. As a result, the protected metal is prevented from corroding.

### PRIOR ART

It is imperative that the electrical connection between the wire and the metal construction has a low transition resistance and is durable compared to the life of the sacrificial anode. In some prior art systems a sacrificial anode is connected to a metal construction through a wire that is welded to the surface of the metal construction. It is previously known also to use one time compositions to provide a connection between the wire and the metal construction.

In a further prior art system pinbrazing is used. A special brazing pin with a metal solder (melting temperature is less than 700° C./1300° F.) is melt down in a hole of a cable lug and creates a brazed connection between the cable lug and the metal construction, for instance a pipeline. A low resistance metal, such as silver can be used. Silver is a very good electrical conductor and will provide an extremely low transition resistance. Normally a pinbrazing gun connected to a power supply is used to melt a brazing pin including a solder material.

In still a further prior art system a threaded pin is used. The threaded pin is brazed onto the metal construction in a conventional manner. In this system the cable has to be connected to a cable lug. Normally, the lug is crimped to the cable. The cable lug of a cable is then placed on the threaded pin and fastened with a nut.

A drawback of using one time compositions is that the compositions have to be treated as explosives. There are strict regulations concerning transport and handling. Consideration also must be given to the problem of a lower grade of repeatability and reproducibility. Existing pinbrazing methods give a good result but in some applications do not comply with standards and requirements. The necessary crimping connection between the wire and the cable lug may result in deteriorated conductivity as a result of an oxidation process in contact surfaces.

### SUMMARY OF THE INVENTION

An object of the invention is to avoid the drawbacks and problems of prior art techniques and to utilize the advantages of the pinbrazing method in an improved system. In accordance with the invention no cable lugs are required to complete an electric connection between the cable and the metal construction.

To provide the connection a curved and bare or stripped section of the wire is pressed against the metal construction. A brazing pin including the necessary solder and flux material is located close to the curved section. Electric power is supplied to the brazing pin and an arc is developed between the pin and the construction. The heat produced in the arc opens the pin to release the flux material and melts the solder. Then the supply of electric power is interrupted and the solder will form a connection between the wire and the metal construction.

It is possible to use a brazing gun in which the brazing pin is inserted and which is provided with means for directing a current through the brazing pin to the metal construction and means for lifting the brazing pin so as to create the arc.

In one embodiment in accordance with the invention the wire is curved by means of a tool including a circular bending head. The tool can be formed as snipe nose pliers, one of the jaws carrying the circular bending head. A stripped end section of the wire is bent around the circular bending head, and is given a ring shaped form. The diameter of the circular bending head corresponds to the diameter of the brazing pin. As a result the brazing pin will engage the underlying metal construction through the circular opening formed by the end section of the wire.

The ring shaped end section of the wire should engage the metal construction along its circumference. To facilitate the engagement of the wire a ferrule preferably is used. The ferrule also will ensure that the brazing gun not will get stuck on the metal construction.

### BRIEF DESCRIPTION OF THE DRAWINGS

In order that the manner in which the above recited and other advantages and objects of the invention are obtained will be readily understood, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1 schematically shows elements of a basic embodiment in accordance with the invention,

FIG. 2 schematically shows elements of FIG. 1 mounted for processing in accordance with the invention,

FIG. 3 schematically shows a pin brazing tool and a brazing pin to be utilized in accordance with the invention,

FIG. 4 schematically shows a wire that has been pinbrazed to a metal surface through a method in accordance with the invention and

FIG. 5 schematically shows a tool that can be used to bend the wire before the pinbrazing process.

### DETAILED DESCRIPTION

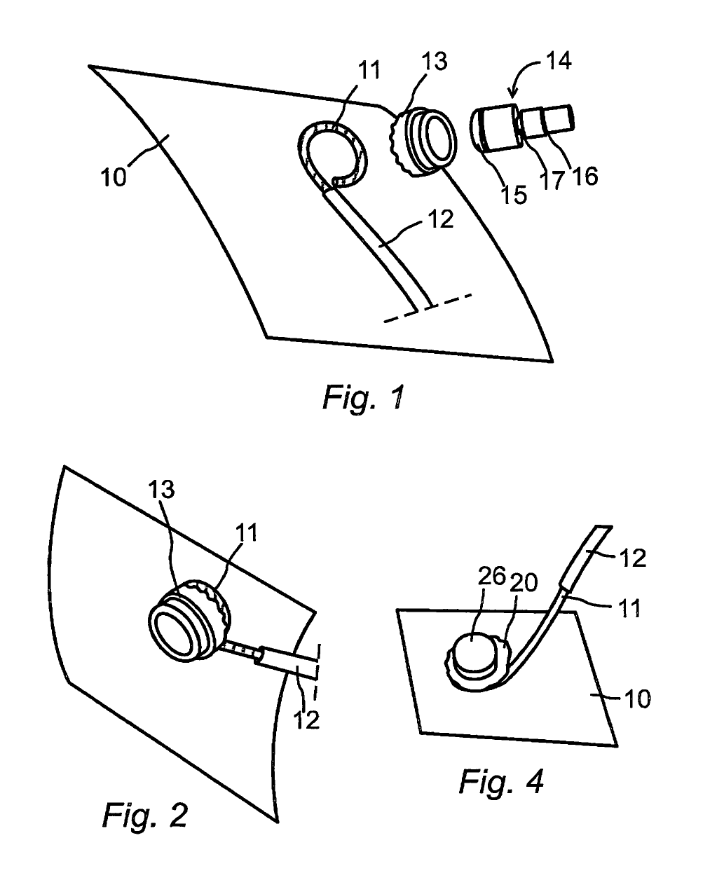

In the embodiment shown in FIG. 1 a stripped section 11 of a wire 12 is to be connected to a metal surface 10, a cut out section only thereof included in the drawing. An end portion 11a of the stripped section 11 of the wire is bent to an open circle. A suitable tool for bending the wire is shown in FIG. 5.

The outer diameter of the circle corresponds to the outer diameter of a ferrule 13 made of a non-conductive material, such as a ceramic material. The ferrule 13 is formed as an open tube having an annular cross section. One end section of the ferrule is wavelike. The wavelike end section will be pressed against the curved end section of the wire during the pinbrazing process and will ensure that no detrimental pressure from gases is created and that oxygen is even distributed to the process. A desired partial shielding also is obtained by the use of the ferrule surrounding the brazing area.

The inside diameter of the ferrule 13 suits an outer diameter of a brazing pin 14 that has a length extending the length of the ferrule. Consequently the brazing pin 14 extends through the ferrule and can be pressed against the metal surface 10 within the curved end section 11a of the wire 11. The brazing pin 14 is made from a metal such as brass and is formed with a capsule, or head portion, 15 and a control shaft or holding portion 16. A narrowing 17 connects the capsule 15 to the holding portion 16.

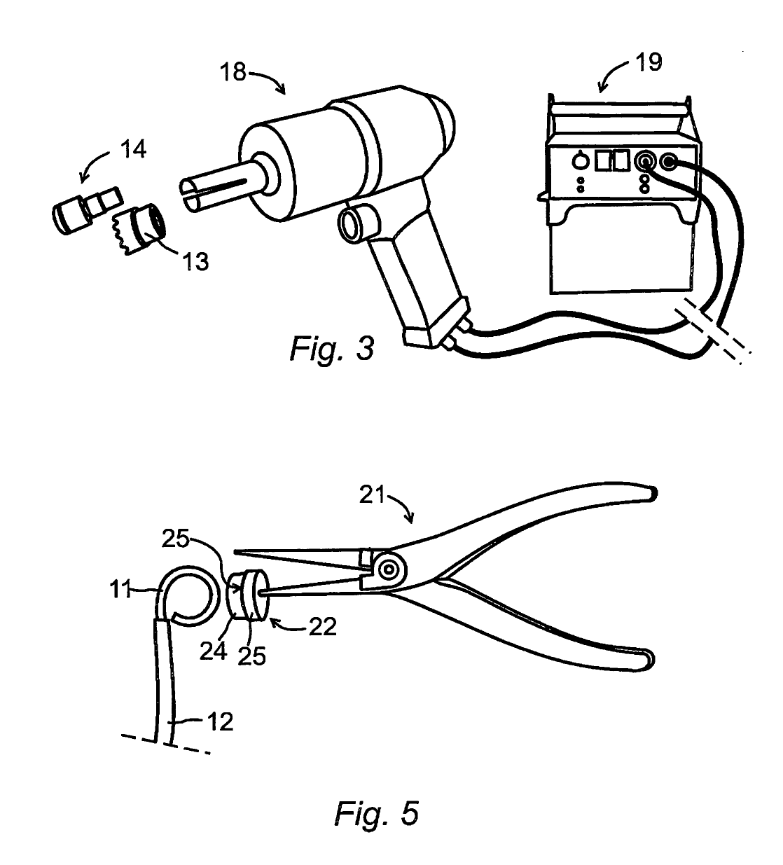

The head portion 15 is formed with a cavity (not shown) containing a solder, preferably made from a silver alloy, and a flux material. The holding portion 16 is designed to be received in a brazing gun (c.f. FIG. 3) and will be disposed of after completion of the brazing process.

In FIG. 2 the ferrule 13 engages and presses the stripped section 11 of the wire 12 against the metal surface 10. This is the position where the pin brazing process is carried out. In practical use the ferrule 13 is carried by the brazing gun together with a brazing pin. The necessary pressure on the ferrule is attained when a user holding the brazing gun presses it against the metal surface.

A suitable brazing gun 18 is shown in FIG. 3 together with a brazing pin 14 and a ferrule 13. The brazing gun 18 is connected to a positive pole and the metal surface, for instance of a pipeline, is connected to the negative pole of a power supply and control unit 19. The stripped and curved end section 11a is placed against a grinded portion of the metal surface that forms a brazing site. A brazing pin 14 is pressed into the brazing gun 18 and positioned against the metal surface within the circular stripped section 11 of the wire. The ferrule 13 will keep the wire in engagement with the metal surface. The pressure of the brazing pin against the metal surface is given by a mechanical spring in the brazing gun 18.

When the circuit is closed by a relay through a switch in the brazing gun 18 a short circuit is created between the brazing pin 14 and the metal surface. The brazing pin 14 constitutes the electrode in the process. At the same time an electromagnet in the power supply and control unit 19 is activated, the force of which is dimensioned to overcome the force form the mechanical spring, to lift the brazing pin 14 up from the metal surface to a pre-set position above it, for example 2 mm, whereas a welding arc is formed between the brazing pin 14 and the metal surface. The solder and the fluxing agent fixed to the brazing pin 14 start melting down below and around the stripped section of the wire.

When the exact amount of energy needed to melt down all the solder on the brazing pin 14 has passed an energy control device included in power supply and control unit 19 turns off the outgoing energy. Simultaneously, the remaining part of the brazing pin 14 is pressed down into the molten material by a force adapted by the mechanical spring. With the mechanism in the brazing gun, a pre-set of ranges of lift applied to the brazing pin 14 is kept exactly the same during different brazing applications.

After completion of the pin brazing process the control shaft of the brazing pin can be knocked off and the result will be as shown in FIG. 4. The curved stripped end section 11a is mostly covered by solder 20 and a firm and electrically excellent connection has been achieved. The solder also has penetrated below and around the curved stripped section 11a. Only a top portion 26 of the brazing pin is left within the curved stripped section 11a.

The quality and durability of the connection between the wire and the metal surface is dependent on penetration and filling of the solder. The circular shape of the stripped section of the wire and the shape of the ferrule will ensure that a substantial portion of the solder will be kept in appropriate spaces. An adaptation of the dimension and form of the curved stripped section to the dimension of the brazing pin will improve the connection.

In FIG. 5 an example of a tool 21 for bending the wire is shown. Needle-nose pliers can form the tool 21. One jaw of the pliers is provided with a bending head 22. In the embodiment shown in FIG. 5 the bending head 22 is of cylindrical shape and divided in rear section 23 and a front section 24 which are separated from the back section by an annular collar 25.

In use a free end of the stripped section of the wire is placed between one jaw and the front section 24 of the bending head 22 and preferably in engagement with the collar 25. Holding the free end in position the stripped section can be bent around the front section of the bending head and thus be given a dimension directly corresponding to the dimensions of the front section 24. By choosing the dimensions of the brazing pin 14 equal or substantially equal to the dimensions of the front section of the bending head the desired adaptation can be achieved.

A major advantage with the device in accordance with the invention is that the connection between a wire and a base element is that the connection will be fully integrated. No connection elements are used in between the wire and the metal surface. This is accomplished without any need for conventional welding equipment and with a completely safe and repeatable method. All components and required equipment are readily stored, transported and used. The resulting electrical connection has a very low transition resistance while at the same time providing an excellent mechanical and structural strength.

1. A method for providing an electric connection between a wire (12) and a metal surface (10), characterised by
pressing a curved section (11a) of the wire towards the metal surface,
arranging a brazing pin (14) in close proximity to a concave side of the curved section (11a), and
supplying electric power to the brazing pin in a pinbrazing process until a fluxing agent and a solder material carried by the brazing pin has been released and melted.

2. The method in accordance with claim 1, further including the step of
bending the wire to circular shape enclosing at least a tip of the brazing pin.

3. The method in accordance with claim 2, further including the step of
bending the wire to circular shape extending at least 300°.

4. The method in accordance with claim 1, further including the step of
engaging the curved section with the metal surface during the pinbrazing process.

5. The method in accordance with claim 4, further including the step of
pressing a ferrule against the curved section of the wire to engage the curved section with the metal surface.

6. A device for providing an electric connection between a wire (11) and a metal surface (10), characterised by
a brazing gun (18) electrically connected to a power supply (19), the brazing gun having an opening for holding a brazing pin (14), the brazing pin having a circular cross section,
a bending tool (21) for bending a stripped section of an electric wire (12) to form a curved section (11a), wherein the diameter of the curved section (11a) is adapted to the diameter of the brazing pin, and
means (13) for pressing the bent wire against the metal surface while generating an arc between the brazing pin and the metal surface.

7. A device in accordance with claim 6, wherein the means for pressing the bent wire against the metal surface comprises a ferrule, the size of a through hole being sufficiently large to receive the brazing pin.
